(19) United States
(12) Patent Application Publication
(10) Pub. No.: US 2011/0258040 A1
(43) Pub. Date: Oct. 20, 2011

(54) SYSTEM AND METHOD FOR PROVIDING FEEDBACK FOR TARGETED COMMUNICATIONS

(75) Inventor: Shanmuganathan GNANASAMBANDAM, Victor, NY (US)

(73) Assignee: Xerox Corporation, Norwalk, CT (US)

(21) Appl. No.: 12/761,985

(22) Filed: Apr. 16, 2010

(51) Int. Cl. G06F 15/16; H04L 9/00; H04Q 5/22; G06Q 30/00

(52) U.S. Cl. 705/14.45; 705/14.64; 705/14.66; 705/14.67; 709/206; 709/217; 713/150; 340/10.1

(57) ABSTRACT

A method of providing a targeted communication to a first device having data communication capabilities and for verifying usage of the targeted communication by a user, the method including: receiving and storing communication generation criteria from a first party; receiving target information from the first device, wherein the target information is associated with the user or the first device; comparing the target information with the communication generation criteria; generating the targeted communication based on results of the step of comparing; delivering the targeted communication to the first device, wherein the targeted communication comprises a verification action; determining if the verification action has been performed; and, storing the targeted communication on the first device or on a second device.

### INCORPORATION BY REFERENCE

The following co-pending applications are incorporated herein by reference in their entireties: U.S. patent application Ser. Nos. 12/245,959, filed on Oct. 6, 2008, 12/424,820, filed on Apr. 16, 2009 and 12/424,858, filed on Apr. 16, 2009.

### TECHNICAL FIELD

The presently disclosed embodiments are directed to providing feedback for targeted communications, e.g., print based communications on printer devices, such as in multi functional devices (MFDs) and print kiosks, in particular relates to a system and method for providing print based communications, quantifying relevant information based on such communications and providing the relevant information to the party or service that produced the communication, e.g., advertisers and advertisement aggregators.

### BACKGROUND

Advertising revenue is often derived from how many people receive or view an advertisement. For example, television advertising costs are based on the popularity of the event during which the advertisements are run, i.e., advertisements run during the Super Bowl are more expensive than advertisements run during the local news. Other mediums have presented different challenges regarding how to track and quantify advertisement coverage.

Tracking advertising effectiveness on the internet has resulted in a variety of models. One of the most popular models is commonly known as the cost-per-click (CPC) model. CPC is based on the idea that, if given the opportunity, a person interested in an advertisement will likely click on the advertisement if additional information or offers are available. Each click is easily tracked or counted and an advertiser may be billed according to the number of clicks on its advertisement. Thus, for example, upon visiting a website, a person may be presented with an advertisement on the web page which is itself linked to another web page or image. If the person is interested in the content of the advertisement they may click on it thereby incurring an additional expense for the advertiser.

Another popular internet advertising model is sometimes referred to as sponsored links. In this model, a search engine, e.g., Google or Yahoo, will place a group of links related to a search at the top or side of a search results page, where each instance that a link is displayed incurs cost for the advertiser.

The various models are often subject to fraudulent practices where an advertiser may incur substantially greater costs than reflected by actual advertisement usage. For example, people have created software which will repeatedly “click” a hyperlink on a web page thereby effectively increasing the click count to a falsely high number. As an advertiser is charged based on the number of clicks on a hyperlink, its cost is increased without the benefit of having the advertisement viewed by a greater number of people. Similarly, sponsored links are also subject to fraudulent practices. Search engines may present a sponsored link for a similar but unrelated search request thereby increasing the fees due to the search provider from the advertiser.

Other advertising methods have proven extremely difficult to quantify and track advertising effectiveness. Targeting communication such as print media advertising, e.g., a printer at a grocery store, business/office or restaurant, has no instant and online feedback mechanisms as to the usage, activity or action performed on the targeted communication or printed advertisement. Moreover, demographic and user information is not provided to the advertisers efficiently because it is not collected near the print medium and there is no equivalent to “clicks” at the place the advertisement is printed, i.e., when picking up the document there is no direct requirement to click or confirm receipt. Thus, print advertisements require lengths of time and some effort on the part of the people receiving the advertisements in order for advertisers to obtain feedback on the effectiveness of the advertising. It is this ineffective transmission of feedback and introduction of delays in the process which makes advertisers prefer online advertising means as opposed to print media advertising. Heretofore, there are no options for a print advertiser to receive efficient feedback regarding the receipt, consideration and/or use of its advertising.

The present disclosure addresses a system and method for providing targeted communications, e.g., advertisements, quantifying relevant information based on the targeted communications and providing the relevant information to interested parties, e.g., advertisers and advertisement aggregators.

### SUMMARY

Broadly, the methods discussed infra provide several levels of “click-through” or feedback for on-demand targeted printed communications, such as advertisements. Such methods can be used where communications are printed along with other transactions, e.g., as a printed receipt, a printed document at work/home or transactional documents including personalized credit card statements. Print click-through (PCT) is a form of verification that is necessary to provide value added services to interested parties, e.g., advertisers, thereby encouraging the interested parties to continue utilizing printed based communications. Similarly, device-click through (DCT) is an analogous form of verification that is necessary to provide value added services to interested parties, e.g., content providers, thereby encouraging the interested parties to continue utilizing the variety of communication forms. It should be appreciated that PCT is a specific form of DCT. Since online advertising leverages capabilities for tracking mouse-clicks (cost per click or CPC oriented feedback processes), advertisers obtain rapid feedback, a facility that has heretofore been lacking in the print media domain. Although previous feedback methods in the print domain are manual and take several days or weeks, the present methods provide several levels of print click-through that vary in terms of click-through speed, security, user actions on promotional material and localization guarantees for user/device, i.e., where the user/device are located geographically. A variety of security techniques may be employed based on the interested party's needs. Moreover, since some of the methods involve user intervention and/or MFD functions, e.g., scanning, to or on printed paper, it is difficult to induce click-fraud which is quite different from web domain communication that is fraught with the aforementioned malpractice.

According to aspects illustrated herein, there is provided a method of providing a targeted communication to a first device having data communication capabilities and for verifying usage of the targeted communication by a user, the method including: a) receiving and storing communication generation criteria from a first party; b) receiving target information from the first device, wherein the target information is associated with the user or the first device; c) comparing the target information with the communication generation criteria; d) generating the targeted communication based on results of the step of comparing; e) delivering the targeted communication to the first device, wherein the targeted communication comprises a verification action; f) determining if the verification action has been performed; and, g) storing the targeted communication on the first device or on a second device.

According to other aspects illustrated herein, there is provided a method for providing a targeted communication and for verifying usage of the targeted communication by a user, the method including: a) receiving and storing communication generation criteria from a first party; b) receiving target information from a first device, wherein the target information is associated with the user or the first device; c) comparing the target information with the communication generation criteria; d) generating the targeted communication based on results of the step of comparing; e) delivering the targeted communication to the first device, wherein the targeted communication comprises a verification action; f) transmitting the targeted communication to a second device after performance of the verification action and storing the targeted communication on the second device; g) providing the targeted communication comprising the verification action at a third device; and, h) comparing the targeted communication stored on the second device with the targeted communication provided to the third device.

According to still other aspects illustrated herein, there is provided a method for providing a targeted communication and for verifying usage of the targeted communication by a user, the method including: a) receiving and storing a set of information associated with the user on a first device; b) providing the set of information associated with the user to a first party; c) generating a custom message based on the set of information associated with the user; d) storing the custom message on the first device; e) receiving at least a portion of the set of information associated with the user on a multi-function device; f) retrieving the custom message based on the at least a portion of the set of information associated with the user; and, g) providing the custom message to the user via the multi-function device.

Other objects, features and advantages of one or more embodiments will be readily appreciable from the following detailed description and from the accompanying drawings and claims.

### BRIEF DESCRIPTION OF THE DRAWINGS

Various embodiments are disclosed, by way of example only, with reference to the accompanying drawings in which corresponding reference symbols indicate corresponding parts, in which:

FIG. 1 is a flow chart of an example of a method of providing a level of click-through for an advertiser;

FIG. 2 is an example of a printed document which includes a printed advertisement;

FIG. 3 is an example of a printed document which includes a printed advertisement and means for searching and/or forward the printed advertisement;

FIG. 4 is an example of a printed document which includes a means of verifying user interest in a variety of topics;

FIG. 5 is a flow chart of an example of a method of providing a level of click-through for an advertiser;

FIG. 6 is an example of discreet groups of printer or MFD devices arranged to communicate between devices within each respective group and between each device and/or group of devices and an advertiser or advertising aggregator;

FIG. 7 is a flow chart of an example of a method of providing a level of click-through for an advertiser;

FIG. 8 is a flow chart of another example of a method of providing a level of click-through for an advertiser;

FIG. 9 is a flow chart of yet another example of a method of providing a level of click-through for an advertiser; and,

FIG. 10 is a chart showing various levels of feedback corresponding to various levels of compensation.

### DETAILED DESCRIPTION

At the outset, it should be appreciated that like drawing numbers on different drawing views identify identical, or functionally similar, structural elements of the embodiments set forth herein. Furthermore, it is understood that these embodiments are not limited to the particular methodology, materials and modifications described and as such may, of course, vary. It is also understood that the terminology used herein is for the purpose of describing particular aspects only, and is not intended to limit the scope of the disclosed embodiments, which are limited only by the appended claims.

Unless defined otherwise, all technical and scientific terms used herein have the same meaning as commonly understood to one of ordinary skill in the art to which these embodiments belong. As used herein, “marking” is intended to be broadly construed as any means, thing, action or mark for identifying a user, an advertiser or an advertisement aggregator via a designator to or on paper. “Designators” or “marks” may include but are not limited to: a small sized image; a small sized image positioned on top of another image; a color variation positioned on top of an image at a certain location on the image; identification of portions of an image using high lighting, tagging, encircling, etc.; a mark made by a certain type of ink or marking device, e.g., a stamp; a scratch; a strike through; a check mark; a high light; a thumb impression or other biometric information; a hole, punch or portion of a piece of paper torn off, e.g., a torn off corner; a hyperlink to a particular image which denotes a class or type of thing as a function of information recognized from a printed paper; a measurement of the length of paper scanned, i.e., a portion of perforated paper may be torn and subsequently scanned; tapping a certain portion of a piece of paper when the paper is placed on a pressure sensitive reader; concentrated disfiguring of a portion of a piece of paper, i.e., a scratch, using a blunt instrument, e.g., a coin, or nails; scratching off ink on a designated printed spot, e.g., certain portions of solid ink printouts may be scratched off and thereby removed from a piece of paper; producing specific sounds on paper by hitting the paper with an object, e.g., finger nails, to indicate a positive response coupled with a sensor loaded recycle bin to denote a negative response; folding a piece of paper to detect a line on the paper, e.g., vertical, horizontal, diagonal, etc., to indicate a response, e.g., yes or no response; and, traditional marking techniques, e.g., one dimensional bar code, two dimensional bar code, color code, glyph, QR code, etc. It should be appreciated that all of the foregoing marking techniques may be utilized to make a printed paper or document clickable. It should be appreciated that verification of marking may occur after a filtration procedure such as character or hand writing recognition, or a filter for low frequency audio signals.

Moreover, as used herein, “action” or “actions” may include but are not limited to: scanning a communication to a tagged repository, email or distribution list; selecting on of several printed pages each of which have a different type of advertisement; tagging after self-identification, such as through a barcode, QR code, mobile device, etc., wherein the tagging includes a complete printed message or a portion thereof as a portion of interest; waiting for a period of time between obtaining the communication and subsequently tagging the communication; waiting for a period of time between obtaining the communication and subsequent use of the communication; waiting for a period of time between obtaining the communication and subsequent disposal of the communication; waiting for a period of time between obtaining the communication and subsequent destruction of the communication; requesting additional information based on the initial communication; requesting other information, such as additional marketing material based on the code or identifying material on the original communication; and, requesting/redirecting such other information via email, mail, facsimile, audio, video, recommendation to others, etc.

Furthermore, as used herein, “click through” is intended to mean feedback, and both terms may be used interchangeably, while “clickable” as used herein is intended to mean a document is capable of provide click through information. Moreover, “print click through” or “PCT” is intended to mean a single feedback transmission, emanating from the printer/MFD or printer/MFD driver, that is provided to the advertiser or advertising aggregator, as a result of a user's action or a printing device event in response to the printing of advertisements or promotional material with or without regular documents being printed or accompanying the former. Thus, “print click through” is defined as a form of verification provided by the printer/MFD to the advertisers and there are several levels of verification provided depending on the multitude of actions performed by the user or device. Still further, as used herein, “aggregator”, “advertising aggregator” and “advertisement aggregator” should be construed broadly to include any organization, company, entity, etc. that collects advertisements in electronic form and subsequently provides them on demand to others, e.g., Google and Yahoo. Moreover, the words “printer,” “printer system”, “printing system”, “printer device” and “printing device” as used herein encompasses any apparatus, such as a digital copier, bookmaking machine, facsimile machine, multi-function machine, etc. which performs a print outputting function for any purpose, while “multi-function device” and “MFD” as used herein is intended to mean a device which includes a plurality of different imaging devices, including but not limited to, a printer, a copier, a fax machine and/or a scanner, and may further provide a connection to a local area network, a wide area network, an Ethernet based network or the internet, either via a wired connection or a wireless connection. An MFD can further refer to any hardware that combines several functions in one unit. For example, MFDs may include but are not limited to a standalone printer, one or more personal computers, a standalone scanner, a mobile phone, an MP3 player, audio electronics, video electronics, GPS systems, televisions, recording and/or reproducing media or any other type of consumer or non-consumer analog and/or digital electronics. “Communication” as used herein is intended to include, but is not limited to, an advertisement, a personalized message, an information feed, e.g., a RSS (Really Simple Syndication) feed, a sales alert, an event listing, a map, or the like. “Targeted communications” as used herein is intended to include communications that are personalized and contextual. “Ads” and “advertisements” as used herein are intended to mean any suitable form of printable promotional material, text message, coupon, targeted coupon, coupon book, targeted route with a coupon, personalized map, personalized event card, an article, a greeting card and the like. Additionally, as used herein, “sheet,” “sheet of paper” and “paper” refer to, for example, paper, transparencies, parchment, film, fabric, plastic, photo-finishing papers or other coated or non-coated substrate media in the form of a web upon which information or markings can be visualized and/or reproduced.

Moreover, although any methods, devices or materials similar or equivalent to those described herein can be used in the practice or testing of these embodiments, some embodiments of methods, devices, and materials are now described.

It should be appreciated that the methods and aspects described herebelow are directed to various modes of communication, for example, an advertisement, a personalized message, an information feed, a sales alert, an event listing, a map, or the like. Although the detailed description is directed primarily to aspects related to advertising and advertisement communications, one of ordinary skill in the art will appreciate that a variety of other modes of communication also fall within the spirit and scope of the claims.

It should be further appreciated that the methods and aspects described herebelow may each incorporate other features. For example, a printer/MFD or printer/MFD driver may analyze the name of the document being printed or may analyze the content of the document and provide context related advertisements based on such analyses. Thus, a keyword or a group of keywords may be established which are used to determine appropriate advertisements. Furthermore, the keywords may be obtained from a document being printed, from a document that was previously printed, from a static set of data associated with the user or device, or from a dynamic set of data associated with the user or device. Moreover, the printer/MFD or printer/MFD driver may utilize location information, temporal, etc., to generate targeted advertisements, e.g., a printer located in Rochester, New York may provide printed advertisements for local Rochester businesses. Such functionality is described in U.S. patent application Ser. No. 12/245,959, which application is incorporated herein by reference.

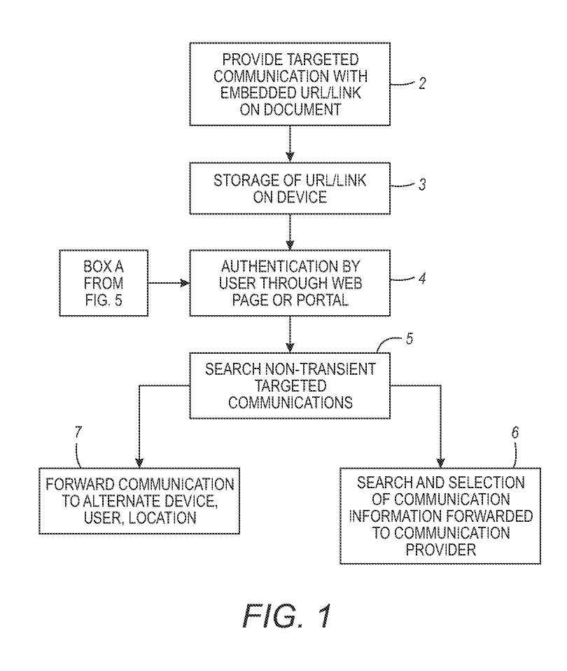

In some aspects, the method may be used in combination with advertisements presented in printed documents as described above. When a user prints and gets advertisements or promotional material in the printed documents, a tiny hyper-link or uniform resource locator (URL), e.g., limited characters unique for a given duration such as a month, is created by the printing device (as shown in step 2 of FIG. 1), is locally stored (as shown in step 3 of FIG. 1) and which points to the printed advertisement. “Locally stored” is intended to mean that the advertisement is stored on the computer from which the document was printed, on a local or remote network accessible computer, or on the printer or print server. The printed document may include a colorful and/or visually attractive advertisement which the user may notice when the printout is retrieved from the printer. Upon returning to a computer, either the computer from which the document was printed or another computer having internet access, the tiny URL may be entered which in turn provides an advertiser with confirmation that an advertisement has been viewed (as shown in step 4 of FIG. 1). Additionally, the user may retrieve the cached ads/coupons that are available to that specific user through the print driver. Via their computer and/or print driver, the user can also search, filter and reprint previously obtained coupons or deals (as shown in step 5 of FIG. 1). Thus, when the user clicks or enters the tiny URL, the print driver “fields” the click on the computer and redirects the click through the printer, which in turn forwards the click back to the advertiser and/or advertisement aggregator (as shown in step 6 of FIG. 1). The tiny URL may be hosted by a printer's web-server and the user may access or search via a browser after she gets back to her desk. Additionally, the user my choose to send the advertisement to another printer, email address, computer, etc. (as shown in step 7 of FIG. 1). It should be appreciated that although the foregoing aspects are described with respect to a printer and/or print driver, further aspects are directed at device where the action originated or is identified by, e.g., a computer or PDA phone.

In some aspects, this method takes advantage of a click-through method that is related to a web domain. However, the method also includes ad caching, non-transient ads, retrieval and searching on demand and print on demand. Contrarily, in the web-domain, the ads are transient and the foregoing click-though method preserves the relatively non-transient nature of printed coupons or ads. Thus, the printer or MFD facilitates an “action” on the URL through a push, e.g., email, or a pull mechanism, e.g., user's browser, and uses that action to provide the click through while providing differentiating features like non-transient ads and ad or coupon search. Additionally, the feedback could take advantage of a collection of actions from multiple media types, such as, the action at a first device, a response to an email, an online search, a RFID recorded on a first device which indicates a unique human presence.

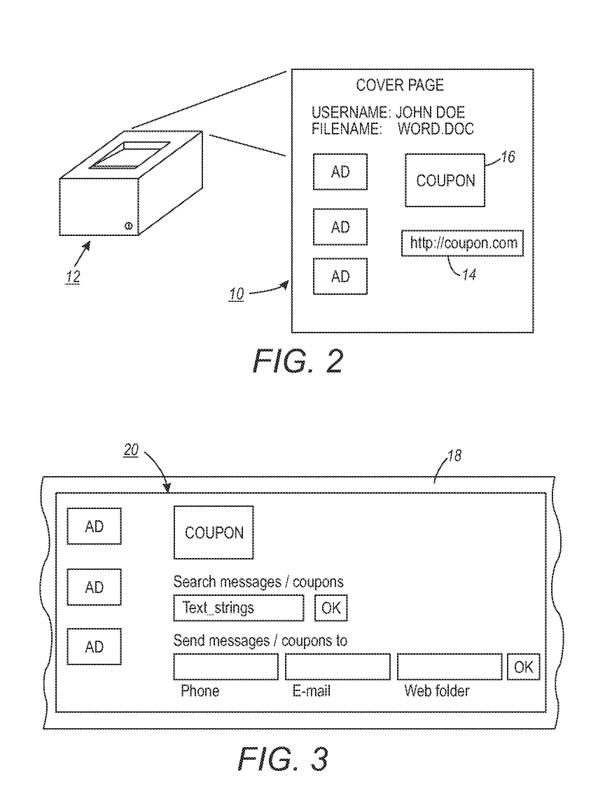

It should be appreciated that the foregoing method can be summarized as follows, which summary is best understood in view of FIGS. 1 and 2. As a user prints document 10, device 12, e.g., printer or MFD, can automatically generate a small URL, glyph, bar code, etc., i.e., identifier 14. Although only a small URL is shown in FIG. 1, it should be appreciated that the form and structure of glyphs and bar codes are independently well known and are therefore not depicted herein. As the user's computer and printer are connected by a device driver, information can be exchanged between the printer and the computer thereby permitting the user to view information resident on the printer at the user's computer. Additionally, such information may be forwarded via known means in the art, e.g., wireless Ethernet, VoIP, bluetooth, 3G, 4G, Wi-Fi, WiMax, ethernet, printing/viewing information as a PDF document, etc., to other devices, e.g., a user's cellular phone. Alternatively, the URL can remain as a persistent URL on the user's computer or on the MFD's interface. Although document 10 including advertisement or coupon 16 is effectively a non-transient advertisement, i.e., the user can retain it indefinitely, the advertisements may be cached and searched at anytime or within a particular period of time after the advertisement's first printing. MFD 18 can internally store information related to users, locations, etc. The user can use the MFD's interface 20 to search previous advertisements or coupons, or alternatively, the MFD interface may be used to forward the previous advertisements or coupons to other locations, e.g., a cellular phone, email address or network accessible folder. In view of the foregoing, it should be appreciated that tracking is available for such information as verifying that the link got stored on the device, when a user logs into a device portal, and all material sent to the user. This information may be used by an advertiser or advertising aggregator so that they may understand when searches are performed and to allow them to forward similar advertisements, coupons, etc., to the user or to other devices.

In some aspects, the method is applicable to advertisements that appear on printed documents, coupons, promotional material, receipts, etc. In this instance and as is explained infra, the printer or MFD is expected to decipher a user's action that is a MFD specific verb, e.g., scan, fax, mark, etc., and/or authenticate using a pre-established authenticating device, e.g., RFID, quick-response code or QR code, etc. In view of the foregoing, it should be appreciated that a number of actions may be received from the user by the MFD within close proximity thereto, and such actions may be used to verify that an advertisement has been viewed, considered and/or used. Moreover, when more than one device such as an MFD are present at a single location, the user's presence near one of those devices permits that deduction that the user is not near other devices, or in the alternative, that the user will be approaching another device shortly.

As advertisements or coupons are printed at a device, area 22 of document 24 is reserved to receive mark 26a on the paper near or next to advertisement 28, e.g., check box 30a, a separate column, etc., as shown in FIG. 3. When the user retrieves the advertisement, the user immediately places a mark on the paper and scans and/or faxes it back to or from the printing device. The device then provides some functionality to incentivize the scanning process, such as an email of the receipt if the content being scanned is a receipt. If the advertisement is a banner page, the printer notes the position of the mark and then emails the original advertisement and more relevant ads based on the expressed preference through the marking on the paper. Regardless of whether or not an incentive is provided, the printer sends information that a mark was placed on a certain ad and forwards this information to the advertiser and/or aggregator as a “click through”. In some aspects, an email can also be send to the user which contains a link that can be clicked on, thereby further connecting the advertisers and the users.

This method takes advantage of the benefits of the MFD such as scanning, optical character recognition, hand writing recognition, auditory pattern recognition, color/electromagnetic frequency recognition, email, etc., to provide feedback to an advertiser. In this method, knowledge of the user is assumed based on what is available in the banner page and/or because only authorized users are allowed to print. In some other situations, a separate registration process is necessary wherein, for example, an RFID tag (radio-frequency identification tag) is provided to a user ahead of time to be used at participating print ad providers. RFID tags are both inexpensive and provide accurate identification. Similarly, quick response (QR) codes may be used with mobile devices as authenticating mechanisms, wherein a QR code is scanned in by an MFD.

In some aspects of the above method, only marked ads are considered clicked through, in the sense that the device can click through for the user by navigating the link. In this method, the device indicates that a machine-based click-though has occurred as guided by the marks on the paper received from the user. Certain credentials, such as through a user's RFID or QR code, may be first obtained before the machine provides a click-through. In order for the advertisers to believe that the credentials are in fact valid, other out-of-band security checking may be needed. For example, prior to a user using a RFID at a device, the user may confirm that they have that RFID at a neutral third party designated for such verification. In some aspects, the machine-based click-through for the above targeted ad example may be implemented to fetch graphical entities from text URLs while providing feedback to the ad aggregator.

In view of the foregoing, it should be appreciated that a specific action must be performed on or near the advertisement by the user, e.g., check a check box or click on a hyperlink. Alternatively, the user can visit an advertising portal provided by the advertiser or advertising aggregator and provide user confirmation similar to a check mark or clicking on a hyperlink. By taking such actions, the user effectively confirms that they are interested in receiving automatic notifications or coupons based upon the selected items. For example, if the user is interested in receiving coupons for pizza deliveries, they make check 26b in box 30b next to the pizza delivery advertisement. In effect, the user is authorizing the printer or MFD to automatically retrieve advertisements on her behalf. As described above, the printed advertisements may include features which permit print click-through information, i.e., feedback, to the advertiser or advertising aggregator. Moreover, as the user has given preauthorization regarding advertisements of interest, click through, e.g., going to a URL, can occur automatically, i.e., click through by proxy. With both automated click through and with the user supplied marking, the advertiser or advertising aggregator gets information about the user in a quick and efficient fashion. In other aspects, the user may receive a RFID tag from the advertiser or advertising aggregator to use for authentication purposes at a MFD. Such a device would allow a user to access information, coupons, advertisements, etc., from any location, e.g., an office, a grocery store or a mall. It should be appreciated that with such an arrangement, the advertisements are non-transient and can be searched at a later time from any location.

In view of the foregoing, aspects of the method may include an user visiting a device, such as an MFD, or an advertising portal (as shown in step 32 of FIG. 5), where the user can sign up for an automated action, e.g., auto-retrieval of particular coupons (as shown in step 34 of FIG. 5). The user can then print a document which includes targeted communications, based on the various user characteristics described above, or alternately based on the input received during step 34 (as shown in step 36 of FIG. 5). Then, the user must take some action, e.g., marking/scanning/forwarding the document via the MFD, (as shown in step 38 of FIG. 5), in order for a leave of click through feedback to be provided to the advertiser. Subsequently, the aspects of the method largely mirror the steps described above with respect to FIG. 1, specifically including steps 4, 5, 6 and 7. It should be appreciated that the time frame within which these steps occur, i.e., t₀ through t₄, describe the work flow of this method, and such work flow may be modified as required by the respective parties involved, e.g., users, print providers, advertisers, etc.

In other aspects, this method assumes two devices, namely the printing device and a click-through device, wherein there is technology to print using one device with so called trails to track the user and printer location, while the click-through device discerns the origin of printing and user's identity and action, such as check marks, encircling or underlining. This method is used when the printing device is not the device that is providing the click-through. Although the feedback in this case might take some time because of the delay in the user carrying the paper from one device to another which are possibly at different geographical locations, it is faster and more detailed than cases where click through is not implemented as outlined in this method, for example, mailed coupons.

Thus, the user prints a document and is provided ads or promotional material at a first location. The printout with the ads also contains some form of identifying information such as identification of the user, spatial information, e.g., location of the printing device, time of day and the such. This is embedded on the printed document in the form of a data-glyph, barcode, QR code or combinations thereof. The user may, after a period, chose to use all or a certain portion of the advertisement at a different location, i.e., at the click-through device. For example, a marked portion of the printed ad may need to be used. The click through device, which also contains technology outlined herein, deciphers the indentifying information, spatial-temporal information and provides the click through back to the aggregator or advertiser.

This method uses two or more print devices that are capable of providing click through for the print domain. Identifying information, unless it is a controlled environment such as the workplace or office, can be through a RFID tag that is provided to the user. In addition, this method may use known techniques such as QR codes, glyphs and barcodes to embed information and to aid tracking.

In view of the foregoing, it should be appreciated that a user can print something at one location, e.g., an office, a mall or a grocery store, and then later retrieve the same advertisement, coupon, etc., from a second location, e.g., a mall or grocery store. It should be appreciated that in some aspects the first and second location malls or grocery stores may each be unique malls or grocery stores. Such an arrangement permits the logging of spatial and temporal information as MFDs are in constant communication with servers, e.g., web servers, advertising aggregators, etc. Similarly, MFDs at different locations may communicate directly with each other. Moreover, a user can opt in or out of particular advertisements so that only the necessary advertisements are provided at a particular location, e.g., only advertisements for stores within a defined distance of a MFD are made available.

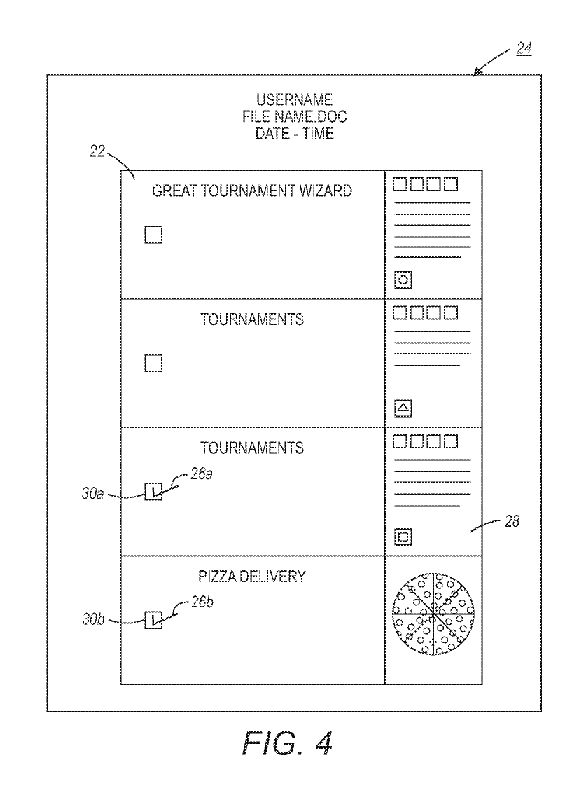

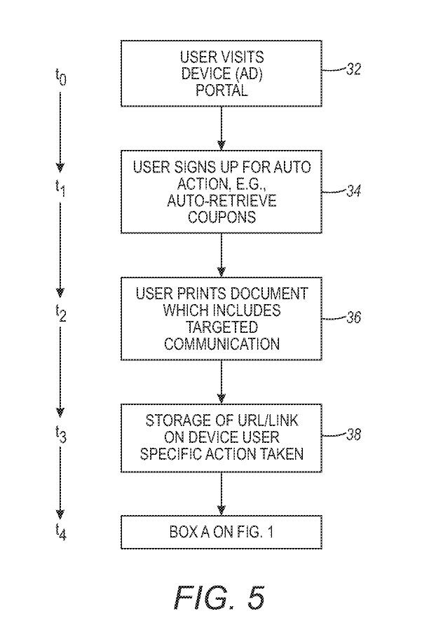

In still yet another aspect of the invention, and as shown in FIG. 4, groups of MFDs or printer devices may be positioned at a plurality of locations, e.g., first and second locations 40 and 42, respectively. Each group of devices includes a plurality of MFDs or printer devices, e.g., MFDs 44a-44d and MFDs 46a-46c. Within each group, the respective devices communicate with each other, and individually or as a group, the respective devices communicate with advertiser or advertising aggregator 48. Thus, the advertiser or aggregator can communicate with all devices and groups of devices, either in serial or in parallel. With such an arrangement, a user can print an advertisement at their office. The office group of devices knows who the user is and what they printed. Moreover, as described above, the devices can predict what advertisements to provide to the user. The office group can communicate with the aggregator, which in turn can communicate with a group of devices at a mall frequented by the user. Based on user interaction or a RFID tag, the group of devices at the mall will become aware of the user as they enter the mall or interact with a device within the group.

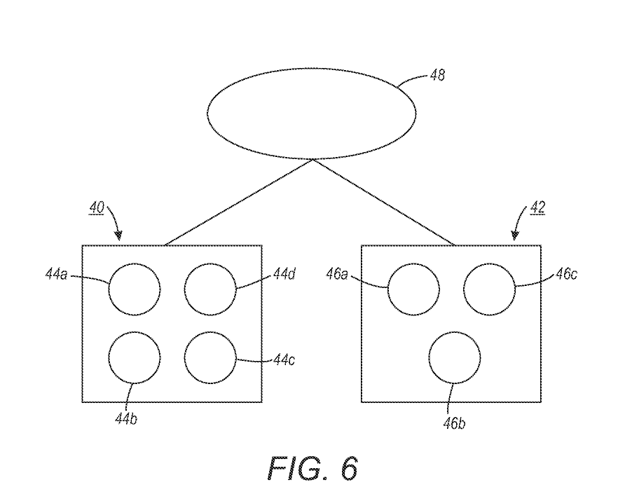

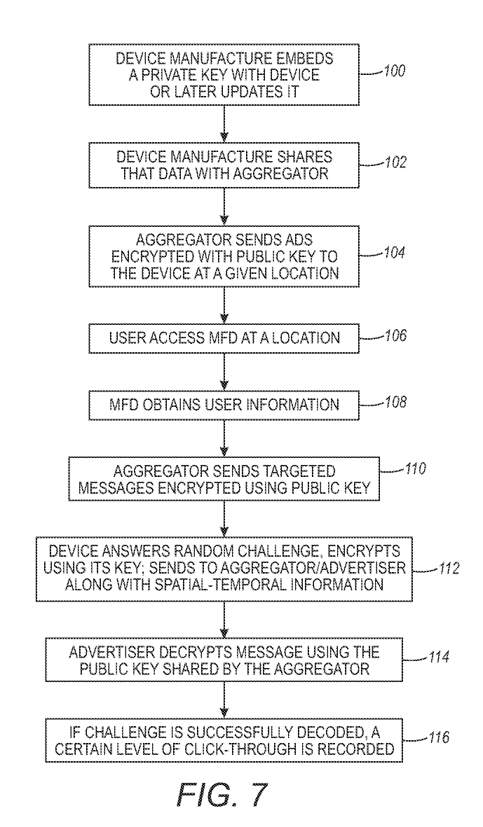

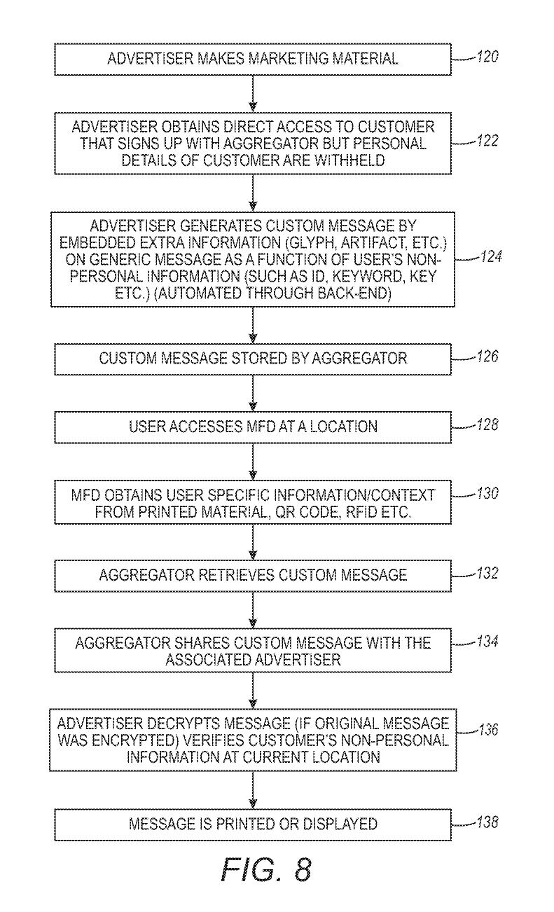

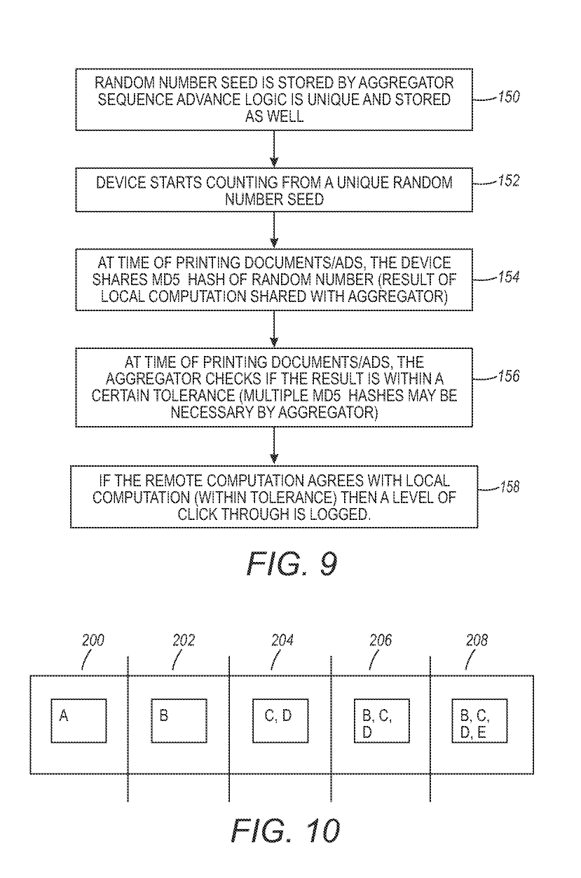

In still yet other aspects, this method uses known key-based security techniques to ascertain if a certain device is indeed the device that printed a certain advertisement or promotional material. (See FIGS. 5, 6 and 7). This provides for geographically localized keys which are apportioned appropriately to certain kinds of devices. For example, at the time of installation, initial purchase or during software setup at a site, a device with the print click-through feature is embedded with a private key belonging to a key-pair that is generated by the advertisement aggregator, e.g., Google, as shown in step 100, and the device manufacturer then shares the private key with the advertisement aggregator, as shown in step 102. The aggregator stores a public key in a repository for later use. At the time when an advertisement is printed, the concerned device identifies itself and the aggregator sends promotional material and ads encrypted using the public key, as shown in step 104. Only the device that has the private key can actually use those ads or alternatively cache them for later use. The private key is thus stored in the device's controller. The device then decrypts the ads and uses them as appropriate. At this point, the aggregator has already obtained some level of click-though because of the pre-established key-based protocol and interaction between related devices.

The aforementioned method provides a layer of security in addition to providing implicit click through, i.e., right at the ad request phase. Other techniques, such as those above are needed, to determine the usage or action taken after the ad is printed, thereby providing an additional level of click-through. For example, the person retrieving the advertisement may subsequently access the MFD at the location of printing the advertisement or at an alternate location, as shown in step 106. The MFD then may prompt the user to provide personal information, survey answers, etc., as shown in step 108. The aggregator may then send targeted messages encrypted using the public key to the MFD, as shown in step 110. A further level of click through may then be provided by the MFD answering a random challenge, encrypting the answer wherein the encrypted communication includes spatial and temporal information and is forwarded to the advertiser/advertising aggregator, as shown in step 112. The receiver of the encrypted communication may then decrypt the communication using its public key, as shown in step 114. Last, if the challenge is successfully decoded and answered, a further level of click through is recorded, as shown in step 116. It should be appreciated that through the registration process, where the keys are established, the location information of the devices or kiosks is known and this provides for an additional dimension that is made available to advertisers for targeting promotional material.

A further aspect of the above method provides that aggregators may work with device makers to provide a black-box that essentially handles the encryption/decryption actions and in the process provides the click-through that is required. This black-box is a trusted piece of hardware or software that the aggregator installs in or on the printing device through a partnership that is established with the printer manufacturer and the aggregator, similar to for example, how Matlab provides its own license server software.

Secure caching of localized ads is also provided for in this method. This decreases network loading for the aggregator as it promotes reuse at the localized printing devices. Given the key-based procedure, fraud is limited as it involves the prohibitive step of breaking the encryption keys. This aspect further distinguishes online methods where links can easily be stolen from search pages or maliciously clicked causing a negative effect for the advertiser, e.g., increased advertising costs.

It should be appreciated that using this method, the advertisers or advertising aggregators can create custom advertisements based on user specific information, as shown in step 120. To do so, the advertiser obtains direct access to customers that sign up with an aggregator; however, customer personal details are withheld from the advertiser, as shown in step 122. A particular image can be created by adding and/or removing specific portions of the image. Moreover, hidden messages may be coded within the image, e.g., using barcodes, glyphs or artifacts, as shown in step 124. The targeted advertisements may be based on specific user information, or may be based on particular, non-identifying user characteristics, e.g., age, sex, location. The advertisement may be generated, provided to the printer device or MFD, and later verified if or who has printed the advertisement. Further click through may be provided by the following method. A custom message may be stored by the aggregator, as shown in step 126. Then upon a user accessing a MFD at a particular location, as shown in step 128, the MFD obtains user specific information/context from, for example, printed material scanned at the MFD, a QR code, a RFID, etc., as shown in step 130. Subsequently, the aggregator retrieves the custom message, as shown in step 132, and then shares the custom message with the associated advertiser, as shown in step 134. The advertiser may then decrypt the custom message, if the message has been encrypted, thereby verifying the customer's non-personal information at the current location, as shown in step 136. The message then may be printed or displayed at the MFD, as shown in step 138. Typically, the printer device and/or MFD are large and not moved from location to location, and therefore the physical location of the device is known. Thus, an advertiser or advertising aggregator will be able to determine that a particular person at a particular location printed the advertisement.

Alternatively, an encryption key may be imbedded within each MFD or printer device. For example, ten MFDs may be positioned throughout a mall with each MFD having a unique key. Thus, as a user obtains an advertisement from each respective MFD, the location where the advertisement was obtained is known. Moreover, when the foregoing is combined with such devices as RFID tags, the system can track the movement of a user before and after printing an advertisement. Through such a pool of devices, advertisers will know, that if an advertisement is made available at a particular location, whether the advertisement was really printed at that location. In this instance, click fraud protection is readily available as a person needs to activate an interface in order to obtain the advertisement. Moreover, advertisers can audit MFDs for security features thereby ensuring that the correct advertisement in the correct location has been printed. Furthermore, such an arrangement permits verification of both printing and use of an advertisement due to the close proximity of the MFD and the point of use of the advertisement.

In some situations, key-based security techniques provide greater security than possible or necessary, i.e., either computationally or security-wise. For example, such a system may include a printer having only a small microcontroller in use. A simpler localization , e.g., assigning geographic regions to devices, and less compute intensive method as opposed to key-based techniques may be necessary. In such situations, the following aspects of the method may be used. The method described below relies on two devices being independently able to count from a certain starting point and verify through a simple comparison how far along on a number sequence they are from the starting point.

At the time of installation or set-up, a unique random number seed s, is installed on every click-though device, per guidance from an aggregator, as shown in step 150. This seed is also stored by the aggregator. It should be appreciated that the size of this code may be smaller than required by applications using strong forms of encryption. The seed itself may be associated with location and/or device information. After the installation of the random number seed, the click-through device begins counting from that number seed, as shown in step 152. At the time the ads and/or promotional material is requested to be printed at the device, the device sends back a certain numerical value to the aggregator which is a function of the original number that was allotted to the device, e.g., an MD5 hash, as shown in step 154. For example, the value sent v that is sent between the aggregator and the device may be simply v=f(s) where f(s) may be a pre-established hash function. f(s) may also be a pseudo-random number sequence and in this case v=f(t, t₀, s) where t is the current time and t₀ is the time the seed was assigned. In this aspect, both the aggregator and the device could compute, independently, a numerical value that has to coincide. Within the protocol, one aspect of the methods may alternately choose to pick the center value of a period in which t resides as v, as opposed to rather the value at t itself. Thus, instead of t, a period T is used in the original equation, i.e., v=(T, t₀, s). This aspect provides for fault-tolerance in that the time-settings are not synchronized. It should be appreciated that the values passed between the devices and the aggregators may also be referred to as hash values. Thus, at the time of printing a document and/or advertisement, the aggregator may check if the result of the click-through device numerical value is within a certain tolerance, as shown in step 156.

Once the values computed independently by both the aggregator and the click-through printer agree, a certain level of click-through is implicitly provided, as shown in step 158. This is because the value s was correlated upon registration time, e.g., when the kiosk or printer was set up, wherein some meta-data about the click-through printer was retrieved. It should be appreciated that ads are sent if the computed values at time t or period T agree. Once the ads are printed, user activity on the ad can additionally be carried out according to previously described aspects of the method.

This method provides for click-through print devices what a “CAPTCHA” system provides for the online environment. By involving a certain small amount of computation predicated on a pre-established secret value, what is commonly referred to as click fraud is prevented. Not every device will have the pre-established secret value and hence a malicious agent cannot pose as a certain click-through device with ease. It should be noted that this secret value may be updated from time to time. This method is further advantageous as it is not as computationally demanding as the key-based security method described above. This is crucial for small printers with limited computation capability. And yet, depending on the semantics with which the secret seed value s is set, geographic localization of the click-through printer is obtained, therefore ads local to a particular key or location may be sent.

As can be seen from the methods above various levels of feedback are provided, for example, ranging from a user getting a link in the email; to ascertaining the identity of a certain click-through printer at a given location; to recognizing marks on paper after it is scanned it; and, to feedback that can be sent within a few minutes to a few days depending on the user introduced delay. Sometimes the feedback can be basic and at other times it can be several confirmations as provided by the aforementioned aspects of the method. It should be appreciated that advertisers, advertising aggregators, parties responsible for targeted communications, etc., may receive compensation based on what type and/or how many levels of feedback occur. For example, as shown in FIG. 10, region 200 represents an instance where feedback type A occurs, region 202 represents an instance where feedback type B occurs, region 204 represents an instance where feedback types C and D occur, region 206 represents an instance where feedback types B, C and D occur and region 208 represents an instance where feedback types B, C, D and E occur. In this example, type A feedback may include CAPTCHA-like fraud resistance, type B feedback may include key-based secured, type C feedback may include MFD feature use such as scanning and/or OCR, type D feedback may include user tracking, demographics and user level access control, and type E feedback may include ad caching, non-transient ads, ad/coupon searching and features analogous to traditional click through technology. With such an arrangement, advertisers, advertising aggregators, and/or parties providing communications will incur increased costs as increased levels of click-through feedback are provided. Thus, for example, click-through feedback provided in accordance with region 200 will result in the lowest cost, while click-through feedback provided in accordance with region 208 will result in the highest cost. One of ordinary skill in the art will appreciate that other arrangements are also possible, for example, a greater number of regions or a cost associated with each type of click-through feedback which is accumulated in accordance with the number of types of click-through feedback utilized, and such arrangements are within the spirit and scope of the claims. Moreover, compensation may not be obtained until a predefined number of click-through feedback actions occur. For example, compensation may not be obtained until feedback types A, B and C are provided.

Some of these forms of feedback are tied to the device features and/or attributes, e.g., that scanning and/or OCR is necessary or a certain device's location is going to be stationary, etc., and that devices can scan RFIDs assigned to users without much difficulty. All of the variables when using a combination of the aforementioned methods and device features, introduce various levels of feedback that can be desired differently by the aggregators. These various levels include but are not limited to: localization and CAPTCHA-like fraud resistance; key-based security; MFD feature use, e.g., scanning or OCR, user tracking, demographics, user level access control; and, advertisement caching, non-transient advertisements, advertisement or coupon searching and traditional click through feedback.

Thus, it should be appreciated that the present methods provide: fraud resistance, including but not limited to CAPTCHA-like features, scanning/marking/faxing/using QR code or RFID and human oriented MFD based actions associated with printed advertisements; light-weight feedback techniques using pseudo-random number sequences or hash functions which are useful for small printers; levels of feedback for click-through monetization in the print domain, i.e., the amount of money made by the click-through provider can be proportional to the level of detail provided in the feedback; and, advertisement caching and non-transient advertisements, cached advertisement searches on the device side, i.e., storing and retrieving advertisements on a printer for later consumption. Moreover, the level of click-through may be further quantized as a cumulative measure of the amount of discreet click-through events which occur within a given transaction. For example, if a user provides a RFID for identification, clicks on an associated hyperlink and the MFD and aggregator share encrypted information therebetween, an increased value is realized by the advertisers and thus an increased cost for such value.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for providing a targeted communication to a first device having data communication capabilities and for verifying usage of the targeted communication by a user, said method comprising:
a) receiving and storing communication generation criteria from a first party;
b) receiving target information from the first device, wherein the target information is associated with the user or the first device;
c) comparing the target information with the communication generation criteria;
d) generating the targeted communication based on results of the step of comparing;
e) delivering the targeted communication to the first device, wherein the targeted communication comprises a verification action;
f) determining if the verification action has been performed; and,
g) storing the targeted communication on the first device or on a second device.

2. The method of claim 1 wherein the communication generation criteria and the target information are selected from the group consisting of: an age of the user; a sex of the user; a first location of the user; a second location of the first device; an association of the user; a selection of the user; a keyword; a period of time the user is at a third location; at least one interest category; a current event; a current offer; a current event related to a fourth location; a facility proximate a fifth location; and, combinations thereof.

3. The method of claim 2 wherein the target information is the keyword and the keyword comprises a portion of a title, a portion of the content, or metadata of a document received by the first device.

4. The method of claim 1 further comprising providing the targeted communication to the user after the step of delivering the targeted communication to the first device.

5. The method of claim 4 wherein the targeted communication is provided in a form selected from the group consisting of: a printed document; a video display; an audio signal; and, combinations thereof.

6. The method of claim 1 wherein the verification action is selected from the group consisting of: forming a small image near the targeted communication; forming a small image on the targeted communication; forming a color variation on or near the targeted communication; tagging or encircling all or a portion of the targeted communication; marking the targeted communication with an ink; scratching all or a portion of the targeted communication; striking through all or a portion of the targeted communication; forming a check mark on or near the targeted communication; providing a biometric information on or near the targeted communication; removing a portion of a document on or near the targeted communication; typing a hyperlink into a user interface; clicking on a hyperlink with an input device; measuring a length of a document comprising the targeted communication; tapping a portion of the document comprising the targeted communication when the document is placed on a pressure sensitive reader; disfiguring a portion of the document comprising the targeted communication; scratching off a portion of an ink on the document comprising the targeted communication; producing a specific sound by striking the document comprising the targeted communication; providing at least one specific electromagnetic frequency to the first device; detecting a folded portion of the document comprising the targeted communication; scanning a one dimensional bar code, a two dimensional bar code, a color code, a glyph or a QR code; facsimile transferring all or a portion of the document comprising the targeted communication; placing a RFID device proximate the first device wherein the RFID device is associated with the user; and, combinations thereof.

7. The method of claim 1 wherein the verification action is selected from the group consisting of: a first action performed on the first device; a second action performed on the second device; and, combinations thereof.

8. The method of claim 1 wherein the first and second devices are each selected from the group consisting of: a multi-function device; a printer; a GPS; a cellular phone; a facsimile machine; a webserver; a computer; a database; a portable electronic device; and, combinations thereof.

9. The method of claim 1 further comprising storing the verification information on the first device or on the second device

10. The method of claim 1 further comprising providing the user access to the targeted communication after the step of storing the targeted communication.

11. The method of claim 10 wherein the user accesses the targeted communication via a computer, a printer, a web browser, an email, a cellular phone or a combination thereof.

12. The method of claim 1 wherein said first party is an advertiser or an advertising aggregator.

13. The method of claim 1 wherein the communication is an advertisement.

14. The method of claim 1 wherein the verification action comprises a plurality of actions and the first party receives a compensation based on the plurality of actions.

15. A method for providing a targeted communication and for verifying usage of the targeted communication by a user, said method comprising:
a) receiving and storing communication generation criteria from a first party;
b) receiving target information from a first device, wherein the target information is associated with the user or the first device;
c) comparing the target information with the communication generation criteria;
d) generating the targeted communication based on results of the step of comparing;
e) delivering the targeted communication to the first device, wherein the targeted communication comprises a verification action;
f) transmitting the targeted communication to a second device after performance of the verification action and storing the targeted communication on the second device;
g) providing the targeted communication comprising the verification action at a third device; and,
h) comparing the targeted communication stored on the second device with the targeted communication provided to the third device.

16. The method of claim 15 wherein the first and third devices are selected from the group consisting of: a multi-function device; a printer; a GPS; a cellular phone; a facsimile machine; a webserver; a computer; a database; a portable electronic device; and, combinations thereof.

17. The method of claim 15 wherein the second device is a computer associated with the first party.

18. The method of claim 15 wherein the first and third devices are positioned in different locations.

19. A method for providing a targeted communication and for verifying usage of the targeted communication by a user, said method comprising:
a) receiving and storing a set of information associated with the user on a first device;
b) providing the set of information associated with the user to a first party;
c) generating a custom message based on the set of information associated with the user;
d) storing the custom message on the first device;
e) receiving at least a portion of the set of information associated with the user on a multi-function device;
f) retrieving the custom message based on the at least a portion of the set of information associated with the user; and,
g) providing the custom message to the user via the multi-function device.

20. The method of claim 19 wherein the custom message is encrypted between the steps of storing the custom message and providing the custom message.

21. The method of claim 19 wherein the first device comprises a public key used to encrypt and decrypt a set of data and the multi-function device comprises a private key used to encrypt and decrypt the set of data passing between the multi-function device and the first device.

22. The method of claim 19 wherein the first device is a computer arranged to interface with the multi-function device via a network.

23. The method of claim 19 wherein the multi-function device comprises a first random number seed which changes over time and is convertible to a first hash value, the first device comprises a second random number seed which changes over time and is convertible to a second hash value, the first device is arranged to compare the first and second hash values and if the first hash value is within a tolerance of the second hash value the first device logs a successful match.

24. The method of claim 19 wherein said first device is an advertising aggregator device.

25. The method of claim 19 wherein said first party is an advertiser.
